(19) United States
(12) Patent Application Publication
(10) Pub. No.: US 2004/0200323 A1
(43) Pub. Date: Oct. 14, 2004

(54) Wrench for recessed nuts

(76) Inventor: Henry Watkins Ellerson, Columbia, VA (US)

Correspondence Address: NASH & TITUS, LLC, 21402 UNISON RD, MIDDLEBURG, VA, 20117, US

(21) Appl. No.: 10/409,476

(22) Filed: Apr. 8, 2003

(51) Int. Cl. B25B 13/56

(52) U.S. Cl. 81/176.15

(57) ABSTRACT

A cylindrical device for removing nuts in recessed locations, comprised of a hollow cylindrical body with physical modifications (lugs, grooves, abrasions, indentations) to one or both ends of the cylinder; cylinder can be made from any firm material that can withstand torque forces applied thereto. The cylinder length is determined by the depth of the recess and the hollow diameters are determined by the internal size of the recess and any rod or other protrusion that must be accommodated within the cylinder to access the nut. The device includes no separate moving parts which may freeze or jam and may be utilized in conjunction with common pliers or other gripping tools.

### BACKGROUND OF THE INVENTION

1. Field of the Invention

The present invention is a wrench that is useful for the removal and re-attachment of a split-face nut such as those found inside a switch assembly or panel in a car.

2. Brief Description of Related Art

Certain electrical switches which control accessories on the 1941 Buick model, and also other years and perhaps other vehicles, are arrayed in two vertical rows on either side of the metal radio speaker grille panel (or glove box in later years) which is centered in the instrument panel and dashboard, characteristic of Buick designs for a number of years. They include:

On the left: Lights, instrument lights and map light;

On the right: Defroster, heater and cigar lighter.

These switches are held fast to the “back” side of the control panel by means of a smoothly circular split-face nut 2 (about ½″ diameter on the flange) that screws through a hole (not shown) in the control panel into a threaded bracket (not shown) attached to the switch assembly itself (not shown). See FIG. 1.

The switch control rods 6 for all such accessories except the map light and the cigar lighter move in and out (front to back) to activate the particular accessory. It is necessary for the control rod 6 (about ⅛″ diameter×2½″ long when extended) to pass through a hole 7 centered in the split-face nut 2 and to move freely in and out while the switch assembly is held fast to the panel by the nut 2.

The split-face nut 2 has a face groove 8 cut about ⅛″ deep across the center of the face 9 of the flange 11 on the nut 2, with the threading 10 of lesser diameter than the flange 11 passing through the hole in the panel. The face-groove 8 also cuts across the hole for the switch control rod 6.

This rod-and-nut assembly resides in a very narrow, hollow, rectangular recess 12 in the control panel behind which the accessory switch assembly is held fast. A chromed rectangular switch handle or knob, not shown, attaches to the outer end of the switch control rod 6 with a set screw when the rod is fully extended, then slips into and against the rectangular face of the recess hole when the control rod is pushed back in to the “off” position; all the chrome switch knobs lie flush with each other in two vertical arrays when “off.” The name of the accessory so controlled is etched into the rectangular face of the switch knob.

The problem presented is the removal and re-attachment of the switch assembly to the control panel by means of loosening and tightening the split-face nut 2, wherein the nut (which has no facets on the sides for gripping) must be firmly gripped and turned within the tight confines of the rectangular recess 12. An ordinary socket wrench is useless because: (a) most are too shallow to accommodate the length of the switch control rod; and (b) there are no facets on the nut to accommodate the usual hex pattern of socket wrenches. Further, the rectangular recess is too deep and narrow to allow firm grip on the split-face nut by either human fingers or even pliers of any sort, including needle-nose pliers. The depth of the rectangular recess is about 1¼ inches. The width of the recess is about 1⅝ inches in Buick models contemplated.

What is needed is a device, such as a wrench, that can firmly grip arid turn the split-face nut within the tight confines of the rectangular recess while accommodating the protrusion of the switch control rod.

Therefore, the object of the present invention is to provide a wrench that grips and turns a recessed split-face nut 2 in the confines of a rectangular recess 12 and accommodates the protrusion of the switch control rod 6.

This and other objects of the invention will become more apparent upon a reading of the full disclosure of the invention.

### SUMMARY OF THE INVENTION

A cylindrical device for loosening and tightening a split-faced nut in confined recesses. The split-faced nut has face grooves thereon. The cylindrical device has

a hollow cylindrical main body having a first end and a second end. The first end has two or more lugs protruding therefrom. The lugs have complimentary shape and dimension for engaging the face grooves of the split-faced nuts. The second end of the cylindrical device is for gripping with a tool for turning loosening or tightening the split face nut.

### BRIEF DESCRIPTION OF THE FIGURES

FIG. 1—A perspective side view of the rectangular recess in the Buick control panel within which are located the split-face nut and protruding switch control rod;

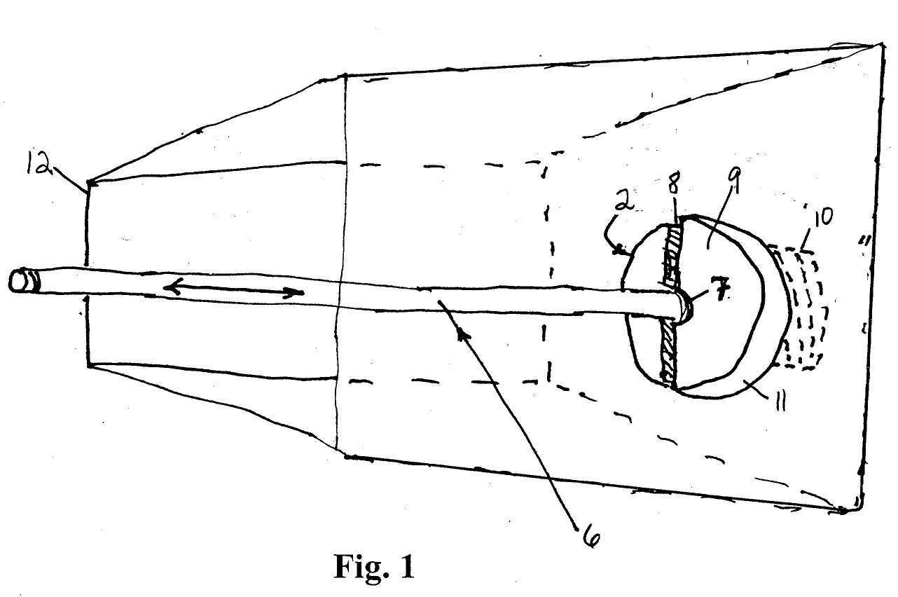

FIG. 2—A perspective view of the split-face wrench showing the hollow interior of the cylinder that accommodates the protruding switch control rod;

FIG. 3—A perspective solid view of the split-face wrench showing the lugs on one end of the cylinder.

### DETAILED DESCRIPTION

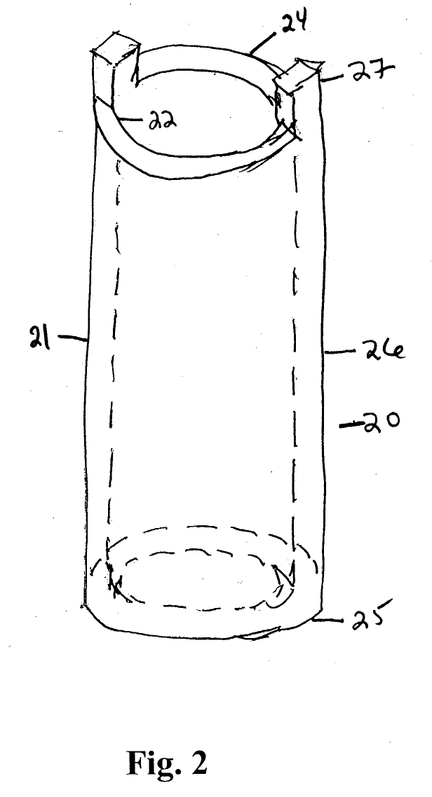

As shown in FIG. 2, a cylindrical device 20 of hollow cylindrical shape has a main body 26 with an outer diameter 21 and an inner diameter 22. The outer diameter 21 is at least 1/8 inch less than the recess 12 which must be accessed and the inner diameter 22 is large enough to accommodate the diameter of the switch control rod 6, and a length allowing full access to the depth of the panel rectangular recess 12 plus enough room to grasp the cylinder second end 25 with common pliers, fingers or other gripping tool. The length of a main body of the cylindrical device can be of any length but a preferred length is three inches. The cylindrical device preferably has an outside diameter of 1 inch maximum and an inside diameter of 1/8 inch minimum.

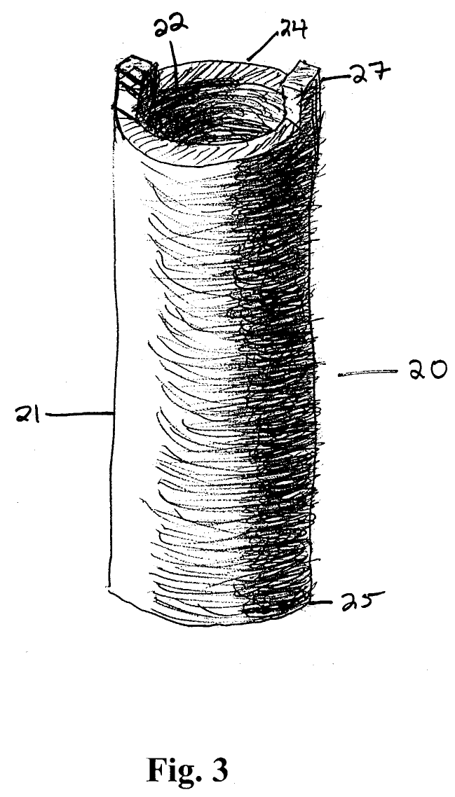

At either first end 24, second end 25 or both ends of the cylindrical device 20 are cut two opposing lugs 27 protruding from an end of the cylindrical device 20. The lugs are configured of a width and depth that is complementary to the width and depth of the face grooves 8 for engaging the split-face nut 2 for turning. An example of a width for a lug that is suitable for the Buick models is approximately 1/8″ for purposes of manipulating the split-face nut 2 as shown in FIG. 3. The lugs 27 fit into the face grooves 8 on the face 9 of the nut 2 to allow the firm turning of the nut for loosening or tightening. Once the nut's threads 10 are free of the threaded bracket on the switch assembly, the nut may be manually extracted while the switch assembly and control rod are withdrawn from the other side of the panel. Of course, the split-face nut 2 cannot be accessed until the chromed switch knob is first removed.

Reinstallation is accomplished by reversing the procedure.

The manner of shaping or cutting the desired configuration of the ends of the cylindrical device 20 is determined by the configuration of the split-face nut(s) 2 to be removed. The rectangular shape of the recess 12 is immaterial to the function of the cylindrical device. The cylindrical device may be fashioned in an infinite range of shapes and sizes to accommodate a split-face nut within a recess, whereby the lugs 27 are shaped accordingly. In another embodiment of the invention, grooves may be cut into the end of the cylindrical device to accommodate protruding lugs, ridges or other protrusions on the face of the flange of the recessed nut. In still another embodiment of the invention, a tacky or abraded coating on the surface of an end of the cylindrical device can be used to turn a rather smooth-faced recessed nut.

The presence or absence of a protruding switch control rod is also immaterial as the device can access a recessed nut of most any configuration. The preferred material for the device is metal, but any rigid, durable material of suitable strength for receiving torque from a turning device for turning the split-face nut is also contemplated. Polymers, plastics, glass, ceramics, or even heavy weight paper are also contemplated. Manufacturing methods that that are suitable for making the device include cutting, shaping, molding, casting, forging, stamping or machining.

Many variations of the present invention are possible within the scope of the invention herein, all of which are encompassed by the presently described device.

Accordingly, the figures, descriptions and discussion are merely meant to illustrate particular embodiments of the device and are not meant to be limitations upon the practice thereof.

What is claimed is:

1. A cylindrical device for loosening and tightening a split-faced nut in confined recesses, wherein said split-faced nut has face grooves thereon, comprising:
a hollow cylindrical main body having a first end and a second end, said first end having two or more lugs protruding therefrom, said lugs having complimentary shape and dimension for engaging said face grooves of said split-faced nuts, said second end for gripping with a tool for turning.

2. The cylindrical device of claim 1, wherein said cylinder is made of a rigid material with enough strength to withstand a torque force applied by said gripping tool during turning said split-faced nut.

3. The cylindrical device of claim 2, wherein said rigid material is metal, polymer, plastic, glass, ceramics, or paper.

4. The cylindrical device of claim 1, wherein said second end has two or more lugs protruding therefrom, said lugs having a complimentary shape and dimension for engaging said face grooves of said split-faced nuts.

5. The cylindrical device of claim 1, wherein said cylindrical device firmly engages the split-face nut for loosening or tightening threads on a split-face nut.

6. The cylindrical device of claim 1, wherein said main body has an outer dimension that is at least 1/8 inch less than an inside dimension of said confined recess.

7. The cylindrical device of claim 1, wherein said main body has an inner dimension large enough to accommodate a switch control rod protruding through a hole defined by said split-face nut in a center of said split-face nut.

8. The cylindrical device of claim 1, wherein said main body has a length of at 3 inches or more.

9. The cylindrical device of claim 6, wherein said outer dimension is about 1/2 inch in diameter.

10. A cylindrical device for loosening and tightening a nut in confined recesses, wherein said nut has a face with an engaging configuration on the surface thereof, said cylindrical device comprising:
a hollow cylinder having a main body, said main body having a first end and a second end, said first end having an engaging configuration thereon, said engaging configuration of said first end being complimentary in shape and dimension for engaging said engaging configuration of said face on said nut, said second end of said hollow cylinder for gripping with a tool for turning.

11. The cylindrical device of claim 10, wherein said engaging configuration on the surface of said nut comprises grooves and said engaging configuration on said first end of said hollow cylinder comprises one or more complimentary protrusions for engaging said grooves.

12. The cylindrical device of claim 10, wherein said engaging configuration on the surface of said nut comprises one or more protrusions and said engaging configuration on said first end of said hollow cylinder comprises complimentary recesses for engaging said protrusions.

13. The cylindrical device of claim 10, wherein said engaging configuration on the surface of said nut and the engaging configuration on said first end of said hollow cylinder comprises a tacky or abraded coating, or other effective means of applying friction and/or torque.

14. A method of loosening or tightening a split-face nut in the confines of a recess of a panel comprising:
a. inserting the cylindrical device of claim 1 into said recess,
b. engaging said split-face nut by inserting said lugs on said first end of said cylindrical device into said face grooves of said split-face nut;
c. grasping said second end of said cylindrical device with a gripping device; and
d. rotating said cylindrical device in a direction to either loosen or tighten said split-face nut to produce the desired result by grasping the device with an ordinary gripping tool such as pliers.
